(19) United States
(12) Patent Application Publication
(10) Pub. No.: US 2014/0013959 A1
(43) Pub. Date: Jan. 16, 2014

(54) FILTERING POT

(71) Applicant: Masakazu Fujii, Rancho Palos Verdes, CA (US)

(72) Inventor: Masakazu Fujii, Rancho Palos Verdes, CA (US)

(21) Appl. No.: 13/546,091

(22) Filed: Jul. 11, 2012

(51) Int. Cl. A47G 19/14; A47J 31/06

(52) U.S. Cl. 99/323

(57) ABSTRACT

The present invention discloses a filtering pot. The filtering pot comprises a covering element, a filtering element, and a pot-body. After assembling the covering element onto the pot-body, the filtering part of the filtering element can enter the pot-body through the opening of the covering element. According to this invention, the shocking of the filtering element will not happen because the filtering element is kept by covering element.

### BACKGROUND OF THE INVENTION

1. Field of the Invention

The present invention is generally related to a filtering pot, and more particularly to a teapot with a filtering set.

2. Description of the Prior Art

Eastern people enjoy making tea with a tea pot just like western people enjoy making coffee with coffee pot. It is un-comfortable for not only eastern but western people to find out tea-leaf/ground coffee residue in their cup during enjoying their drink. Therefore, some people will pour coffee or tea through a filtering net before into cups to remove the residue. And, it becomes a little un-conveniently for making coffee or tea.

There is some other solution to solve the mentioned problem by combination a cup and a filtering net set, such as the French Press set. This solution is more conveniently, but it cannot be applied onto a general teapot. For above-mentioned reasons, the more prefect design is needed.

### SUMMARY OF THE INVENTION

In view of the above background and in order to fulfill the requirements of industry, a new design of a teapot with filtering set is provided in the present invention.

One subject of the present invention is to provide a filtering pot. The filtering pot comprises a covering element, and the covering element can perfectly replace the cover of a teapot. The mentioned covering element can fit onto the teapot, and cover the opening of the teapot as the original cover. Besides, the covering element can assist to keep a filtering element from shocking in the teapot.

According to above-mentioned objectives, the present invention discloses a filtering pot. The filtering pot comprises a covering element, a filtering element, and a pot-body. The covering element can be fixed onto the pot-body. The filtering element can enter the pot-body through the opening of the covering element. According to this invention, the extending part of the covering part can assist to keep the filtering element from shocking in the pot-body. Through employing this filtering pot, the residue of tea-leaf or ground coffee will be keep in the filtering element and not appear in the user's cup. Preferably, through choosing suitable size of the covering element, the mentioned filtering pot can be applied to any general teapot. So that people still can use a general teapot to make tea or coffee without pouring out residue.

### BRIEF DESCRIPTION OF THE DRAWINGS

FIG. 1 shows a filtering pot diagram of the present invention;

FIG. 2 shows the cross-section diagram of the filtering pot of this present invention;

FIG. 3 shows a filtering pot diagram of the present invention; and

FIG. 4 shows the cross-section diagram of the filtering pot of this present invention.

### DETAILED DESCRIPTION OF THE PREFERRED EMBODIMENTS

What is probed into the invention is filtering pot. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

One preferred embodiment according to this specification discloses a filtering pot. The filtering pot comprises a covering element, a filtering element, and a pot-body. The covering element can be fixed onto the pot-body. The filtering element can enter the pot-body through the opening of the covering element. According to this invention, the extending part of the covering part can assist to keep the filtering element from shocking in the pot-body. Through employing this filtering pot, the residue of tea-leaf or ground coffee will be keep in the filtering element and not appear in the user's cup. Preferably, through choosing suitable size of the covering element, the mentioned filtering pot can be applied to any general teapot. So that people still can use a general teapot to make tea or coffee without pouring out residue.

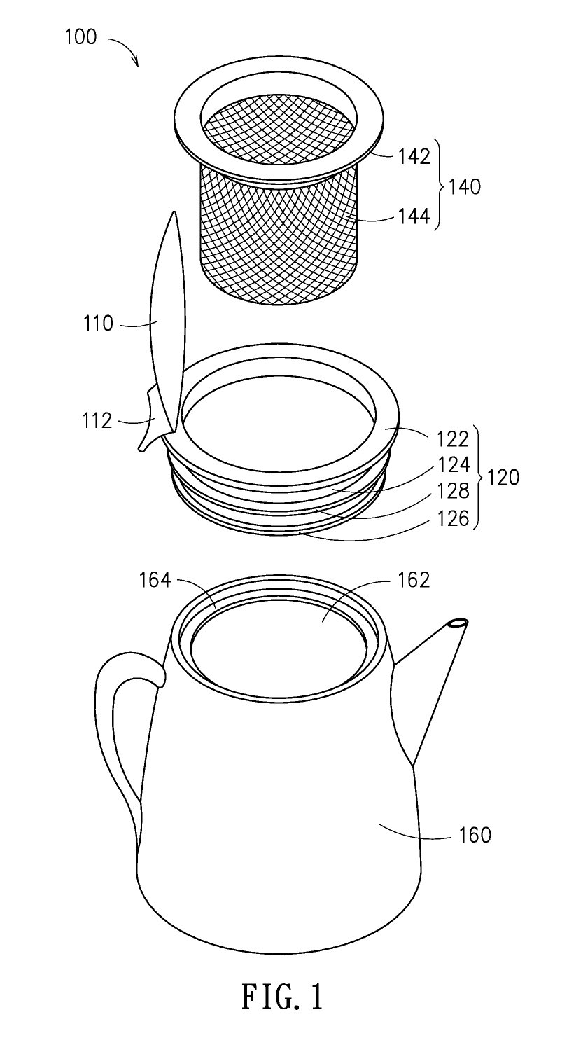

Another preferred embodiment discloses a filtering pot. FIG. 1 is a diagram of a filtering pot 100 of this embodiment. The filtering pot 100 comprises a covering element, a filtering element 140, and a pot-body. Referred to FIG. 1, the covering element comprises a upper cover 110, and a fixing unit 120. There is an opening through the fixing unit 120. The size of the upper cover 110 can cover the opening of the fixing unit 120. The fixing unit 120 comprises a base part 122, a extending part 124 extending from one side of the base part 122, a first extruding part 126, and a second extruding part 128. The first extruding part 126 is at the other end of the extending part 124. The second extruding part 128 is between the base part 122 and the first extruding part 126. The second extruding part 128 is a ring shape extrusion. The upper cover 110 is axially positioned on the base part 122 through a push part 112. Through pushing the push part 112, the upper cover 110 will cover onto or move out of the opening of the fixing unit 120.

In one preferred example of this embodiment, the base part 122 can be covered with a soft material. In one preferred example, the mentioned extending part 124, the first extruding part 126, and the second extruding part 128 can be made of soft material, such as rubber, silicon, and so on. When the fixing unit 120 is assembled onto the pot-body 160, the base part 122 is put onto and surround the upper opening 162 of the pot-body 160, and the extending part 124, the first extruding part 126, and the second extruding part 128 can enter the pot-body 160 through the upper opening 162. In one preferred example, the extending portion 164 of the pot-body 160 will be embedded into the space between the first extruding part 126 and the second extruding part 128 to keep the assembly of the covering element and the pot-body 160. In another preferred example, the extending portion 164 of the pot-body 160 will be embedded between the first extruding part 126 and the second extruding part 128, and the first extruding part 126 will against the inside wall of the pot-body 160 around the extending portion 164. According to the design of this invention, the covering element with suitable size of this invention can be used to replace the original cover of a tea pot.

The filtering element 140 comprises a flat part 142, and a filtering part 144. The size of the opening of the fixing unit 120 is bigger than the size of the filtering part 144, so that the filtering part 144 can pass through the opening of the fixing unit 120. In one preferred example of this invention, the size of the opening of the fixing unit 120 is close to the size of the filtering part 144, and the filtering part 144 can pass through the opening of the fixing unit 120. The filtering part 144 comprises a plurality of mesh. In one preferred example of this invention, the filtering part 144 comprises a plurality of filter net with the same mesh size. In another preferred example of this invention, the filtering part 144 comprises a plurality of filter net with different mesh size respectively. According to this invention, the materials, such as tea leaf, ground coffee, herb, vanilla, etc., can be put into the filtering element 140 for next immersion.

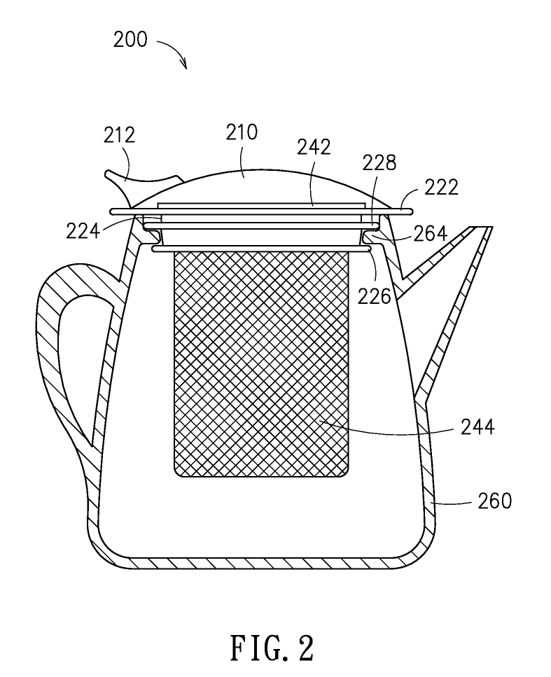

FIG. 2 is a cross-section diagram of the filtering pot 200 of this invention. After assembling, the base part 222 of the fixing unit is perfectly surrounding the opening of the pot-body 260, and the extending part 224, the first extruding part 226, the second extruding part 228 can enter the inside of the pot-body 260. Referred to FIG. 2, the extending portion 264 of the upper opening of the pot-body 260 can be embedded between the first extruding part 226 and the second extruding part 228 for ensuring the assembly of the fixing unit and the pot-body 260. In one preferred example, the first extruding part 226 will be against the inside wall of the pot-body 160 around the extending portion 264 for ensuring the assembly of the fixing unit and the pot-body 260. The upper cover 210 can completely cover the opening of the fixing unit. The upper cover 210 is controlled by the push part 212 to cover onto or remove from the opening of the fixing unit.

As shown in FIG. 2, when the filtering part 244 passing through the opening of the fixing unit and entering the pot-body 260, the flat part 242 is lain on the base part 222, so that filtering element will not fully fall into the pot-body 260. The extending part 224 can surround and assist to keep the filtering part 244 from any shocking in the pot-body 260. The filtering element can further comprise a handle part, not shown in the figures. In one preferred example, the handle part can be axially mounted onto the inside of the filtering element. In another preferred example, the handle part can be axially mounted onto the inside of the filtering element and near the flat part 242 through two bolts, and the handle part can be rotated peripherally and axially by the bolts. The filtering element can be move out from the pot-body 260 by the handle part.

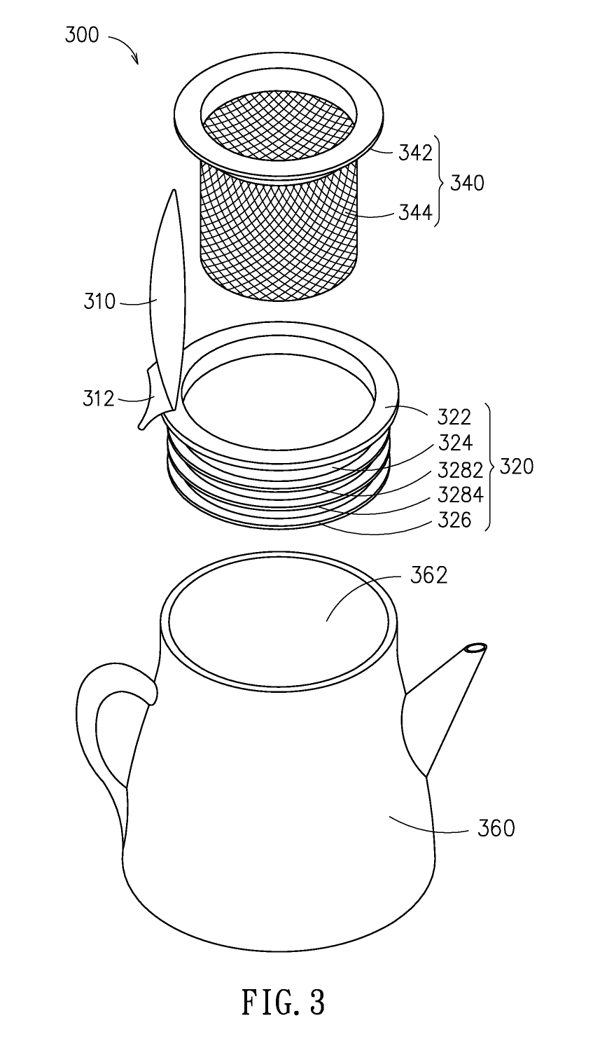

Still another preferred embodiment discloses a filtering pot. FIG. 3 is a diagram of a filtering pot 300 of this embodiment. The filtering pot 300 comprises a covering element, a filtering element 340, and a pot-body. Referred to FIG. 3, the covering element comprises an upper cover 310, and a fixing unit 320. There is an opening through the fixing unit 320. The size of the upper cover 310 can cover the opening of the fixing unit 320. The fixing unit 320 comprises a base part 322, an extending part 324 extending from one side of the base part 322, a first extruding part 326, and at least one second extruding part. The first extruding part 326 is at the other end of the extending part 324. The second extruding part(s) 328 is extended from the extending part 324 and is between the base part 322 and the first extruding part 326. The second extruding part is a ring shape extrusion. In one preferred example of this embodiment, as shown in FIG. 3, there are two second extruding parts 3282 and 3284 positioned between the base part 322 and the first extruding part 326. The upper cover 310 is axially positioned on the base part 322 through a push part 312. Through pushing the push part 312, the upper cover 310 will cover onto or move out of the opening of the fixing unit 320.

In one preferred example of this embodiment, the base part 322 can be covered with a soft material. In one preferred example, the mentioned extending part 324, the first extruding part 326, and the second extruding parts 3282 and 3824 can be made of soft material, such as rubber, silicon, and so on. When the fixing unit 320 is assembled onto the pot-body 360, the base part 322 will be put onto and surrounding the upper opening 362 of the pot-body 360, and the extending part 324, the first extruding part 326, and the second extruding parts 3282 and 3284 can enter the pot-body 360 through the upper opening 362. In one preferred example, the first extruding part 326, and the second extruding parts 3282 and 3284 can against the pot-body 360 inside wall neighboring the upper opening 362 to keep the assembly of the covering element and the pot-body 360. According to the design of this invention, the covering element with suitable size of this invention can be used to replace the original cover of a tea pot.

The filtering element 340 comprises a flat part 342, and a filtering part 344. The size of the opening of the fixing unit 320 is bigger than the size of the filtering part 344, so that the filtering part 344 can pass through the opening of the fixing unit 320. In one preferred example of this invention, the size of the opening of the fixing unit 320 is close to the size of the filtering part 344, and the filtering part 344 can pass through the opening of the fixing unit 320. The filtering part 344 comprises a plurality of mesh. In one preferred example of this embodiment, the filtering part 344 comprises a plurality of filter net with the same mesh size. In another preferred example of this embodiment, the filtering part 344 comprises a plurality of filter net with different mesh size respectively. According to this invention, the materials, such as tea leaf, ground coffee, herb, vanilla, etc., can be put into the filtering element 340 for next immersion.

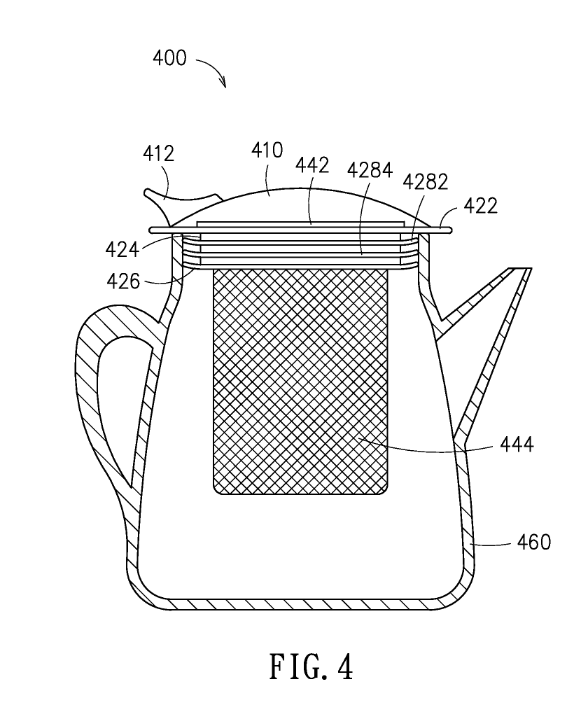

FIG. 4 is a cross-section diagram of the filtering pot 400 of this invention. After assembling, the base part 422 of the fixing unit is perfectly surrounding the opening of the pot-body 460, and the extending part 424, the first extruding part 426, the second extruding parts 4282 and 4284 can enter the inside of the pot-body 460. As shown in FIG. 4, the first extruding part 426, the second extruding parts 4282 and 4284 are against the inside wall neighboring the upper opening of the pot-body 460 to keep the assembly of the fixing unit and the pot-body 460. Referred to FIG. 4, the first extruding part 426, the second extruding parts 4282 and 4284 are bended against the inside wall of the pot-body 460, and the bend of the first extruding part 426, the second extruding parts 4282 and 4284 is helpful to ensure the assembly of the fixing unit and the pot-body 460 through friction. The upper cover 410 can completely cover the opening of the fixing unit. The upper cover 410 is controlled by the push part 412 to cover onto or remove from the opening of the fixing unit.

As shown in FIG. 4, when the filtering part 444 passing through the opening of the fixing unit and entering the pot-body 460, the flat part 442 is lain on the base part 422, so that filtering element will not fully fall into the pot-body 460. The extending part 424 can surround and assist to keep the filtering part 444 from any shocking in the pot-body 460. The filtering element can further comprise a handle part, not shown in the figures. In one preferred example, the handle part can be axially mounted onto the inside of the filtering element. In another preferred example, the handle part can be axially mounted onto the inside of the filtering element and near the flat part 442 through two bolts, and the handle part can be rotated peripherally and axially by the bolts. The filtering element can be move out from the pot-body 460 by the handle part.

In view of the above, this invention discloses a filtering pot. The filtering pot comprises a covering element, a filtering element, and a pot-body. The covering element can be assembled onto the upper opening of the pot-body. The filtering element can pass through the opening of the covering element and enter the pot-body. The extending part of the covering element can assist to keep the filtering element from any shocking in the pot-body. According to this invention, after assembling the filtering pot, user can put material into the filtering element, pour hot water into the pot-body through the opening of the covering element, and put on the upper cover for immersing. After few minutes, the filter element can be removed from the filtering pot with the immersed material. Therefore, the solution poured from the pot-body will not appear residue of the material.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A filtering pot comprising:
a covering element comprising an upper cover, and a fixing unit, wherein said fix unit comprises a base part, a extending part extending from one side of said base part, a first extruding part, and at least one second extruding part, wherein said first extruding part is at the other end of the extending part, wherein said second extruding part is between said base part and said first extruding part;
a filtering element comprising a flat part and a filtering part extending from one side of said flat part, wherein said filtering part comprises a plurality of mesh; and
a pot-body;
when assembling the covering element onto the upper opening of the pot-body, the base part is surrounded the upper opening of the pot-body, wherein the upper cover can completely cover the opening of the fixing unit, when the filtering part passing through the opening of the fix unit and entering the pot-body, the flat part of the filtering element is lain on the base part.

2. The filtering pot according to claim 1, wherein the pot-body comprises an extending portion, wherein the extending portion is extending from the upper opening of the pot-body, wherein when assembling the covering element onto the upper opening of the pot-body, the extending portion is embedded between the first extruding part and the second extruding part.

3. The filtering pot according to claim 1, wherein when assembling the covering element onto the upper opening of the pot-body, the first extruding part and the second extruding part are against the inside wall neighboring the upper opening of the pot-body.

4. The filtering pot according to claim 3, wherein when assembling the covering element onto the upper opening of the pot-body, the first extruding part and the second extruding part are bend to ensure the assembly of the covering element and the pot-body through friction.

5. The filtering pot according to claim 1, wherein when the extending portion embedded between the first extruding part and the second extruding part, the first extruding part against the inside wall of the pot-body around the extending portion.

6. The filtering pot according to claim 1, wherein said filtering element further comprises a handle part axially mounted onto the inside of the filtering element and near the flat part through.

7. The filtering pot according to claim 1, wherein the filtering part comprises a plurality of filter net with the same mesh size.

8. The teapot according to claim 1, wherein the filtering part comprises a plurality of filter net respectively with different mesh size.

9. The filtering pot according to claim 1, wherein the covering element further comprises a push part, wherein the upper cover is axially positioned onto the base part and the push part can control the upper cover to cover onto or move from the opening of the fixing unit.
